(19) United States
(12) Patent Application Publication
(10) Pub. No.: US 2012/0324575 A1
(43) Pub. Date: Dec. 20, 2012

(54) System, Method, Program, and Recording Medium for Detecting and Blocking Unwanted Programs in Real Time Based on Process Behavior Analysis and Recording Medium for Storing Program

(75) Inventors: Byeong Ho Choi, Daejeon (KR); Chol Su Im, Daejeon (KR)

(73) Assignee: ISE Information Co., Ltd., Daejeon (KR)

(21) Appl. No.: 13/580,958

(22) PCT Filed: Apr. 27, 2010
(86) PCT No.: PCT/KR2010/002642

§ 371 Date: Aug. 23, 2012

(30) Foreign Application Priority Data
Feb. 23, 2010 (KR) 10-2010-0016330

(51) Int. Cl. G06F 21/00

(52) U.S. Cl. 726/23

(57) ABSTRACT

A system, method and program for detecting and blocking unwanted programs in real time based on process behavior analysis and a recording medium for storing the program. In particular, the invention relates to a system, method and program for detecting and blocking unwanted programs in real time based on process behavior analysis and a recording medium for storing the program, in which a security server defines lists of unwanted abnormal actions of a process in advance, detects the number of abnormal actions that have occurred, collects the abnormal actions, and detects and blocks an unwanted process by matching a program executed on a user terminal with the lists of abnormal actions.

### CROSS-REFERENCE TO RELATED APPLICATIONS

This application is the U.S. national phase of the International Patent Application No. PCT/KR2010/002642 filed Apr. 27, 2010, which claims the benefit of Korean Patent Application No. 10-2010-0016330 filed Feb. 23, 2010, the entire content of which is incorporated herein by reference.

### FIELD OF THE INVENTION

The invention relates to a system, method and program for detecting and blocking unwanted programs in real time based on process behavior analysis and a recording medium for storing the program so as to detect and block malicious programs that are operating in a system in various forms.

### BACKGROUND

With the rapid development of Internet infrastructures and the expansion of the popularity of the Internet, malicious programs threatening the security of users' Personal computers (PCs) have gradually become intelligent and diversified, and damage caused by malicious programs has gradually increased.

Therefore, the development of such Internet infrastructure technology may result in large damage to security and to the protection of personal information contrary to expectations. That is, a high-performance computer is used as the specific zombie computer of a botnet or is infected with worms, so that the development speed of computer performance has increased when another infection target computer is searched for, and thus the speed of the spreading of damage has also increased.

The problems of these threatening components are also taken advantage of even for information wars and then have the potential threat of being used for cyber crimes, cyber war or cyber terror.

In particular, the security of traffic, banking, energy and national system networks has become more and more important.

The reason for this is that the national information infrastructure is the base network which is the basis of entire fields of the economy and society, and thus they must be securely protected and managed against any threats. When the infrastructure of a country is being threatened and faltering, even national defense as well as the society and economy may be in widespread chaos.

As examples thereof, there were Internet security accidents such as the Distributed Denial-of-Service (DDoS) attacks on root name servers on Oct. 21, 2002, Structured Query Language (SQL) slammer worm attacks on Jan. 25, 2003, MyDoom virus attacks in 2004, and large-scale DDoS attacks caused by 25,000 zombie PCs on Jul. 7, 2009, which shows that threats have increased in this way.

Those accidents show that the entire Internet can be influenced by attacks due to representative accidents which attack the vulnerability of the Internet infrastructure.

Those malicious programs are programs which infiltrate into a user PC and process operations irrelevant to the user's intention or perform abnormal functions, and collectively refer to programs such as viruses, worms, the Trojan horses, BackDoors and SpyWare.

Malicious programs have various forms depending on the types thereof, but have the common characteristics of performing abnormal operations differing from normal operations, for example, the operation of accessing other programs or Operating Systems (OS) to change the code or extract information, the operation of transmitting or receiving abnormal network packets, or the concealment operation of concealing the presence of a malicious program from a security program.

Initially, those malicious programs were tools expressing simple curiosity or showing off their presence, whereas, recently, they exhibit the problems of causing the acquisition of money and inducing malicious damage.

Further, initially, malicious code such as viruses, BackDoors, Rootkits and Trojan horses were moved individually, whereas recently they occur in a composite form, and thus it is very difficult to control those types of malicious code.

In particular, most malicious code going around the Internet is open to the public in the form of open source code, so that anyone can fabricate malicious code and distribute mutant malicious code. Accordingly, there is a problem in that a zero-day attack, in which an attack caused by malicious code is made before even one day passes after the occurrence of a vulnerable security point, can be realized.

It is possible to cope with unwanted programs having similar code patterns by using a conventional signature scheme in which a malicious program is acquired and the code thereof is analyzed and in which malicious actions can be prevented only when a pattern signature required to eliminate the malicious program is formed, and by using a heuristic technology which is proposed such that the code of an existing unwanted program is analyzed and then the inflow and behavior of a subsequent unwanted program that may occur in the future can be prevented. However, there are problems in that it is impossible to cope in real time with unwanted programs which are newly generated and mutant unwanted programs which are varying intelligently.

### SUMMARY

Accordingly, an embodiment of the invention protects a system against various types of malicious programs, which are mutant or unknown, by analyzing various types of actions so as to detect and block unwanted programs which are operating in various forms.

Another embodiment of the invention allows a manager and a user to easily establish policies related to malicious programs and actions taken thereby, thus detecting and blocking in real time the behavior of unwanted programs so that the manager and the user themselves and other persons can be prevented from suffering damage.

An embodiment of the invention provides a method of detecting and blocking unwanted programs in real time based on process behavior analysis, comprising a security server defining a list of unwanted program scenarios in advance; and matching a program, executed on a user terminal based on an agent program, with the unwanted program scenarios, thus detecting and blocking an unwanted process.

In the method, the list of unwanted program scenarios comprises lists of abnormal actions such as occurrence of a session, transmission of packets to multiple Internet Protocol (IP) addresses, occurrence of spoofing, transmission/reception of packets, opening and generation of files, Interrupt Descriptor Table (IDT) hook detection, generation and opening of a service, access to physical memory, generation of processes, access to a different process, invasion of principal function tables of an operating system, behavior of concealing a relevant program's actions, registration of program auto start-up, an attempt at keyboard hacking, registry concealment, access to other processes, behavior of invading address space of other processes, nameless processes, parentless processes, generation of execution files, writing mode of execution files, loading of device drivers, and behavior of compulsorily terminating other processes.

In the method, the list of unwanted program scenarios is configured such that one or more lists of abnormal actions are combined to form each singular scenario, and one or more singular scenarios are combined to form a composite scenario.

In the method, each of the lists of abnormal actions further comprises at least one dummy abnormal action which ignores any actions.

In the method, the user terminal is connected to the security server while accessing the security server over the network until the agent program is terminated.

In the method, a method of detecting the unwanted process is implemented using any one selected from among a method of detecting, as an unwanted process, an process running under a name identical to that of an operating system when the unwanted process is running, a method of simultaneously tracking actions of a network and a process when an unwanted process is running, and then detecting actions of the unwanted process using a combination of scenarios, a method of detecting checksums and then detecting an unwanted process running while being parasitic on a normal process, a method of tracking a parent process and a child process generated thereby in real time via process tracking, and then eliminating an initially generated unwanted process and detecting a child process which is generated by the initially generated unwanted process and is running under a name of another process of the operating system, and a method of detecting an unwanted process, which is running by injecting code into a normal process, using a hooking detection and restoration technique.

In the method, a method of blocking the unwanted process is implemented, in a case of network packets, using a method of blocking all packets of a relevant process, and is implemented, in a case of process packets, using any one selected from among, a method of compulsorily terminating a relevant process, a method of blocking packets of the relevant process for a specific time period, and a method of providing a simple alert.

The method further comprises the security server establishing detection and blocking scenario policies related to abnormal actions, analyzing the scenario policies for individual types, and distributing the scenario policies to the user terminal; and the user terminal applying the abnormal action-related detection and blocking scenario policies received from the security server to a kernel stage.

Another embodiment of the invention provides a system for detecting and blocking unwanted programs in real time based on process behavior analysis, the system having a plurality of user terminals and a security server individually connected to the user terminals over a network, wherein each of the user terminals comprises an action monitoring module for monitoring actions of a process, a process tracking and Process Identification (PID) detection module for tracking actions of a process, abnormal actions of which have been detected, and detecting Process Identification (PID) of the process, a scenario blocking module for combining lists of actions taken by a relevant process for a given time period and blocking the relevant process when the actions match those of a composite scenario, a checksum blocking module for blocking a relevant process when a checksum of an execution program thereof matches a previously obtained checksum, a hooking detection and restoration module for, when an unwanted program is operating by injecting code into another process so as to conceal itself, detecting the unwanted program and restoring an original program, and an exceptional process database (DB) for examining a relevant process for an exception to action-based monitoring and then processing the relevant process as the exception to action-based monitoring; and the security server comprises an analysis module for analyzing statistical information received from the user terminals, a security measure module for collecting information about abnormal actions occurring in the user terminals and blocking of unwanted programs in the user terminals, thus taking security measures, and an overall DB for storing information about blocking conditions, occurrence of abnormal actions on each of the user terminals, and unwanted programs.

In the system, the security server further comprises an exceptional process DB transferred to each of the user terminals and used to determine an exception to action-based monitoring; and a blocking scenario DB transferred to the user terminal and used to perform process action-based matching and blocking.

A further embodiment of the invention provides a program for detecting and blocking unwanted programs in real time based on process behavior analysis, in which unwanted programs are detected and blocked in real time based on the above-described process behavior analysis.

Another embodiment of the invention provides a recording medium for storing the program in computer-readable form.

According to the above-described embodiments, the invention is advantageous in that abnormal actions taken by unwanted programs are analyzed and used in real time, thus protecting a user terminal against various types of unwanted programs which are mutant or unknown.

Further, the invention is advantageous in that a user can easily establish a security policy suitable for his or her environment, thus flexibly coping with variation in the user's environment or with the appearance of new unwanted programs.

Furthermore, the invention is advantageous in that a zero-day attack can be detected and blocked, thus reducing damage that occurred in conventional vaccine programs because generating and distributing a cure signature takes a long time.

### BRIEF DESCRIPTION OF THE DRAWINGS

FIG. 1 is a block diagram showing a system for detecting and blocking unwanted programs in real time based on process behavior analysis according to an embodiment of the invention; and

FIGS. 2 and 3 are flowcharts showing a method of detecting and blocking unwanted programs in real time based on process behavior analysis according to an embodiment of the invention.

### DETAILED DESCRIPTION OF THE INVENTION

Hereinafter, preferred embodiments of the invention will be described in detail with reference to the attached drawings.

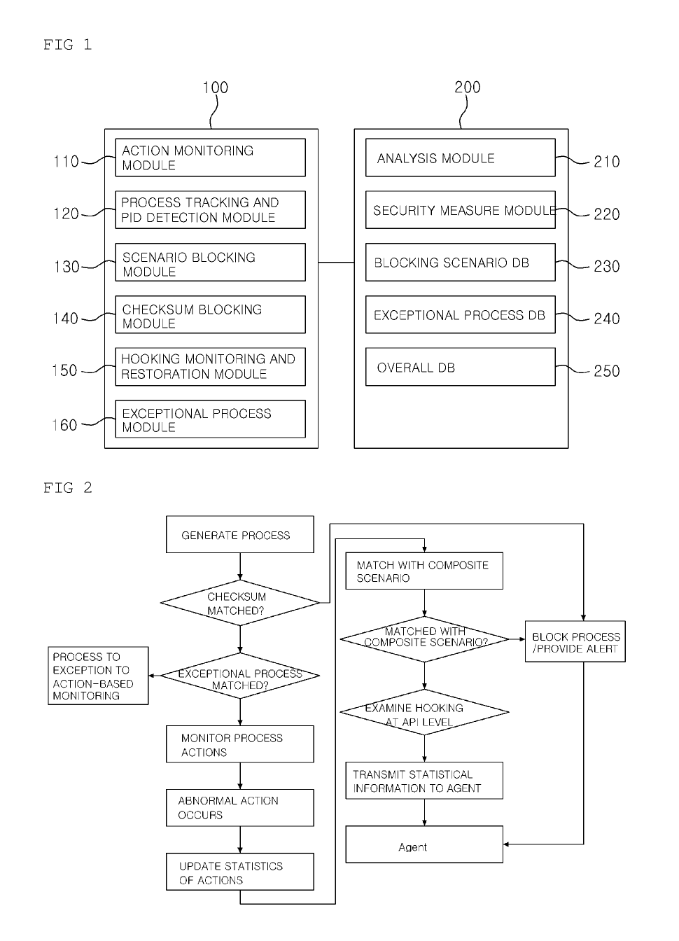

As shown in FIG. 1, an embodiment of the invention comprises a user terminal and a security server.

A user terminal 100 includes an action monitoring module 110, a process tracking and Process Identification (PID) detection module 120, a scenario blocking module 130, a checksum blocking module 140, a hooking monitoring and restoration module 150, and an exceptional process module 160.

A security server 200 includes an analysis module 210, a security measure module 220, a blocking scenario database (DB) 230, an exceptional process DB 240, and an overall DB 250.

The action monitoring module 110 of the user terminal 100 monitors the actions of each process, and the process tracking and PID detection module 120 tracks the actions of a process, the abnormal actions of which have been detected, and detects the PID of that process.

The scenario blocking module 130 compares a list of the sequences of actions, taken by a process for a given time, with a blocking scenario, and blocks the process when the sequences of the actions match those of the blocking scenario.

The checksum blocking module 140 blocks a relevant process when the checksum of the execution program of the process matches a previously obtained checksum.

When an unwanted program injects code into another process and is operating using the code so as to conceal itself, the hooking detection and restoration module 150 detects the injection of the code and restores the original process.

The exceptional process module 160 processes each process, which matches processes stored in the exceptional process DB 240 received from the security server 200, as an exception to monitoring/blocking.

The analysis module 210 of the security server 200 analyzes statistical information received from the user terminal 100, and determines the tendency of an attack or the occurrence of attacks by a plurality of attackers.

The security measure module 220 takes measures such as the registration of an additional blocking scenario or the spreading of blocking scenarios on the basis of the results of the analysis by the analysis module 210.

The overall DB 250 stores information about blocking conditions, the occurrence of abnormal actions on each user terminal 100, and unwanted programs.

The exceptional process DB 240 is transferred to each user terminal 100 and is used to determine exceptions to action-based monitoring.

The blocking scenario DB 230 is transferred to each user terminal 100 and is used to perform process action-based matching/blocking.

In a method of detecting unwanted programs in real time based on process behavior analysis by using the above-described construction, the security server defines in advance a list of unwanted program scenarios.

In this case, the list of unwanted program scenarios comprises lists of abnormal actions such as the occurrence of a session, the transmission of packets to multiple Internet Protocol (IP) addresses, the occurrence of spoofing, the transmission/reception of packets, the opening and generation of files, Interrupt Descriptor Table (IDT) hook detection, the generation and opening of a service, access to physical memory, the generation of processes, access to a different process, the invasion of principal function tables of an operating system, the behavior of concealing a relevant program's actions, the registration of program auto start-up, an attempt at keyboard hacking, registry concealment, access to other processes, the behavior of invading address space of other processes, nameless processes, parentless processes, the generation of execution files, the writing mode of execution files, the loading of device drivers, and the behavior of compulsorily terminating other processes.

Each of the lists of abnormal actions further comprises dummy abnormal actions which ignore any actions. The dummy abnormal actions will be described again later in a method of detecting an unwanted process via matching with the lists of abnormal actions.

Next, an unwanted process is detected and blocked by matching a program which is executed on the user terminal with the unwanted program scenarios.

A method of detecting the unwanted process by matching the execution program with the lists of abnormal actions will be described below.

First, the action of a process, in which an unwanted program is operating by disguising itself as a program identical to that of an Operating System (OS) when the unwanted program is operating, is analyzed, thus detecting whether the process is a malicious process.

In this case, all processes necessarily perform some actions of the abnormal action list at the time of running. Each scenario having sequential actions is generated by combining actions which have been performed for a predetermined time period, with the number of actions. Abnormal actions may be dummy abnormal actions indicating that any actions capable of occurring between the actions of the scenario are able to be included in the dummy abnormal actions although not included in the scenario. A composite scenario with n singular scenarios is generated by combining the individual scenarios. When actions of a relevant program sequentially match the singular scenarios of the composite scenario, the relevant program is determined to be an unwanted program.

Table 1 shows an example of the detection of a mutant process and a new process, based on scenarios.

Table 1 shows the moment at which a relevant process is actually proved to be an unwanted program when the unwanted program is operating according to the scenario thereof after being executed, and also shows detailed portions in which four processes running in the current system are detected as unwanted programs by “action A, action B and action C”.

The four processes have mutant relationships and comprise the actions of the same pattern although they are slightly different from one another in the overall behavior. Mutant programs have slightly different portions although they are not entirely different from the existing program.

When unwanted program 1 performs “action A”, a blocking engine records that the unwanted program 1 performed “action A”, and examines all scenarios. If a driver has a scenario which blocks a relevant program once “action A” merely occurs, blocking/alert data is immediately generated.

Otherwise the blocking engine continuously pays attention to unwanted program 1 until “action C” occurs.

At the moment at which “action C” occurs, the blocking engine blocks unwanted program 1 because a scenario matching “action C” is present.

The blocking log contains the basic information (process ID and name) of the unwanted program which is currently being blocked, and the scenario ID and blocking values of the scenario by which the unwanted program is blocked. The blocking values refer to the detailed values of the abnormal action components of a relevant process.

When a single action is set as a scenario, most processes may be blocked, so that only malicious programs other than normal programs must be detected and blocked by the relevant scenario using a combined concept in which abnormal actions are combined with each other.

Scenarios are combined for example as {[access to external network, once], [generation of execution file, once], [registration of auto-execution, once], and [process execution, once]}. This scenario refers to a combination of actions operated such that a hacker accesses a network, downloads an execution file, generates a file, and allows the file to be currently executed while registering the auto-execution of the file so that the file can always be executed.

The system for detecting and blocking unwanted programs in real time based on process behavior analysis according to the invention considers only the actions of a malicious program without referring to information such as the external form of a process, the size of a file, and checksums, thus detecting and blocking new/mutant malicious programs and coping with malicious programs, the external forms of which are continuously changing

Table 2 shows an example for describing dummy abnormal actions.

As shown in Table 2, when there is a scenario having dummy actions and there is a process having [abnormal action A], [abnormal action C], [abnormal action J] and [abnormal action K], the closest matching is realized with respect to scenario 2.

The third dummy action of scenario 2 indicates that any action may take place regardless of the type of action. When [abnormal action K] occurs as the fourth action of the process, the scenario 2 is selected as a matched scenario and is used to detect the process.

Second, when an unwanted process is running, the actions of the network and the process are simultaneously tracked, so that the actions are detected by a combination of scenarios.

Here, since all the processes generate their own PIDs when running, a process performing a unwanted action is detected using its own unique ID (PID), but, when the unique ID of the process cannot be found due to the asynchronism of the OS, the low-level modules of the OS are analyzed/tracked, and thus the unique ID of the process is found.

Third, an unwanted process which is running while being parasitic on a normal process is detected by detecting a checksum.

In this case, by using a method of comparing the checksum of an execution program which has been previously obtained in a normal state with the checksum of the execution program which is obtained in real time from a kernel, the injection of malicious code into a normal program or the change of the code of the normal program is detected.

Further, a process in which a checksum is set is examined for an exception using the checksum, and a process in which a checksum is not set is examined for an exception using the name of the process.

When a process has both a name and a checksum (process name +checksum), the process is examined for an exception using the checksum. Further, when a process has only a name, the process is examined for an exception using only the name of the process. Here, the name of the process is designated as a full path.

Fourth, a parent process and a child process generated thereby are tracked in real time by process tracking, so that an initially generated unwanted process is eliminated, and a child process, which is generated by the unwanted process and is running to disguise itself under the name of an OS process, is detected.

In this case, when the initially generated process is detected by the blocking scenario, the PID of the child process generated by that process is tracked, and thus the child process is detected.

Fifth, an unwanted process which is running by injecting code into a normal process is detected using a hooking detection and restoration technique.

In this case, using a driver hooking detection and application hooking detection technique, lists of processes which inject code and processes and modules which are injected with the code, are detected, and those processes and modules are restored, thus detecting that an unwanted program is operating while being parasitic on/injected into the OS.

The method of blocking an unwanted process by matching with the lists of abnormal actions maybe, in the case of network packets, a method of blocking all packets of a process and may be, in the case of process packets, any one of a method of compulsorily terminating the process, a method of blocking packets/prohibiting the running of the process for a specific time period, and a method of providing a simple alert.

The invention comprises a program for detecting and blocking unwanted programs in real time based on process behavior analysis, and a recording medium for storing the program in a computer-readable form.

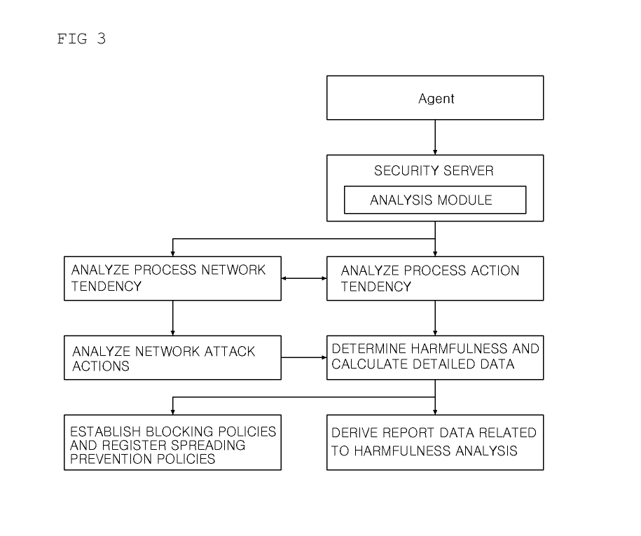

As shown in FIGS. 2 and 3, the system for detecting and blocking unwanted programs in real time based on process behavior analysis is a system for simultaneously detecting and blocking unwanted programs for a group of user terminals within an organization. The system comprises a security server connected to a plurality of user terminals, which individually perform action-based monitoring, over a network and configured to receive event information occurring in each user terminal and to establish a blocking policy at the group level.

Whether a process is a primary blocking target is determined using the checksum thereof when an execution program is being executed on each user terminal. When the process matches the primary blocking target, the relevant process is immediately blocked.

In this case, when the process does not match the primary blocking target, whether the process is an exception to action-based monitoring is determined. When the process matches the exceptional process, it is processed as an exception to action-based monitoring.

Processes which do not match the exceptional process continuously undergo action-based monitoring. When any abnormal action occurs, an action statistical value is immediately accumulated, and thereafter whether a relevant process matches a blocking scenario is determined.

A process having succeeded in matching with the blocking scenario is blocked depending on the blocking conditions of the scenario and alert information is generated, whereas a process having failed to match with the blocking scenario undergoes a hooking examination at an Application Programming Interface (API) level, and thus whether a hacking action has occurred is determined. Accordingly, when the determination has succeeded, the process is blocked and alert information is generated.

When the process does not match the blocking scenario, or does not match hooking at the API level, the system transmits the statistical information of the process to an agent, and waits for a subsequent action to occur.

In this case, the agent is provided in the user terminal and is configured to receive composite scenario information required for blocking from the security server, transmit a composite scenario policy to a device driver which is operating at the kernel level and performs action-based monitoring/blocking, and then performs the real-time matching of the composite scenario when the actions of all processes of the user terminal occur.

Further, control such as the start and stoppage of the device driver is performed by the agent, thus allowing the agent and the device driver to be regarded as one program.

When the action transition information of a program is compared in real time with the blocking scenarios, and a scenario matching the action transition information is found, the relevant process is regarded as an unwanted program, and thus a blocking policy is generated.

Further, as shown in FIG. 3, when the security server receives information about the statistics of process actions, the statistics of the process network, the statistics of process file access, and process blocking alerts from the agent, the security server immediately transmits data to the analysis module, thus enabling the tendency of the process networks and the tendency of the process actions to be analyzed.

When the two types of tendencies are analyzed, there is an advantage in that the occurrence of unwanted processes which cannot be detected using only network information can be determined by analyzing the actions of the process.

Since the analysis of the tendency of the network is the analysis of a plurality of user terminals rather than a single process, attacks by a plurality of attackers such as DDoS attacks, or even attacks on social engineering networks which are difficult to detect, can be detected.

The harmfulness of a process is determined based on information derived from the analysis of the tendency of process actions, and detailed process information is calculated.

By using the above methods, information analyzed and determined to be a new or mutant malicious program which is not yet known is represented by report data. Blocking scenarios are established based on the details of the process actions, and blocking policies are propagated in advance to other user terminals which have not yet been contaminated by malicious programs, so that spreading prevention policies, required to immediately block a malicious process when the malicious process is detected, are registered.

The overall contents of the invention are summarized in brief as follows.

The agent is installed in each user terminal and is configured to continuously operate while the user terminal is being executed, and to monitor in real time the actions of all processes running in the user terminal.

In this case, if there is a newly executed process, the agent also monitors it.

The agent accesses the security server over a Transmission Control Protocol (TCP)/Internet Protocol (IP) network, and keeps accessing the security server until the agent is terminated. The security server manages agents installed in a plurality of user terminals so that the agents keep accessing the security server in real time.

As described above, although the various embodiments have been disclosed for illustrative purposes, those skilled in the art will appreciate that various modifications are possible, without departing from the scope and spirit of the invention. Therefore, the scope of the invention should not be limited to the above-described embodiments and should be defined by the accompanying claims and equivalents thereof.

### DESCRIPTION OF REFERENCE CHARACTERS

100: user terminal
110: action monitoring module
120: process tracking and PID detection module
130: scenario blocking module
140: checksum blocking module
150: hooking monitoring and restoration module
160: exceptional process module
200: security server
210: analysis module
220: security measure module
230: blocking scenario DB
240: exceptional process DB
250: overall DB

1. A method of detecting and blocking unwanted programs in real time based on process behavior analysis, comprising:
a security server defining a list of unwanted program scenarios in advance; and
matching a program, executed on a user terminal based on an agent program, with the unwanted program scenarios, thus detecting and blocking an unwanted process.

2. The method according to claim 1, wherein the list of unwanted program scenarios comprises lists of abnormal actions such as occurrence of a session, transmission of packets to multiple Internet Protocol (IP) addresses, occurrence of spoofing, transmission/reception of packets, opening and generation of files, Interrupt Descriptor Table (IDT) hook detection, generation and opening of a service, access to physical memory, generation of processes, access to a different process, invasion of principal function tables of an operating system, behavior of concealing a relevant program's actions, registration of program auto start-up, an attempt at keyboard hacking, registry concealment, access to other processes, behavior of invading address space of other processes, nameless processes, parentless processes, generation of execution files, writing mode of execution files, loading of device drivers, and behavior of compulsorily terminating other processes.

3. The method according to claim 2, wherein the list of unwanted program scenarios is configured such that one or more lists of abnormal actions are combined to form each singular scenario, and one or more singular scenarios are combined to form a composite scenario.

4. The method according to claim 2, wherein each of the lists of abnormal actions further comprises at least one dummy abnormal action which ignores any actions.

5. The method according to claim 1, wherein the user terminal is connected to the security server while accessing the security server over the network until the agent program is terminated.

6. The method according to claim 1, wherein a method of detecting the unwanted process is implemented using any one selected from among a method of detecting, as an unwanted process, an process running under a name identical to that of an operating system when the unwanted process is running, a method of simultaneously tracking actions of a network and a process when an unwanted process is running, and then detecting actions of the unwanted process using a combination of scenarios, a method of detecting checksums and then detecting an unwanted process running while being parasitic on a normal process, a method of tracking a parent process and a child process generated thereby in real time via process tracking, and then eliminating an initially generated unwanted process and detecting a child process which is generated by the initially generated unwanted process and is running under a name of another process of the operating system, and a method of detecting an unwanted process, which is running by injecting code into a normal process, using a hooking detection and restoration technique.

7. The method according to claim 1, wherein a method of blocking the unwanted process is implemented, in a case of network packets, using a method of blocking all packets of a relevant process, and is implemented, in a case of process packets, using any one selected from among, a method of compulsorily terminating a relevant process, a method of blocking packets of the relevant process for a specific time period, and a method of providing a simple alert.

8. The method according to claim 1, further comprising:
the security server establishing detection and blocking scenario policies related to abnormal actions, analyzing the scenario policies for individual types, and distributing the scenario policies to the user terminal; and
the user terminal applying the abnormal action-related detection and blocking scenario policies received from the security server to a kernel stage.

9. A system for detecting and blocking unwanted programs in real time based on process behavior analysis, the system comprising a plurality of user terminals and a security server individually connected to the user terminals over a network, wherein:
each of the user terminals comprises an action monitoring module for monitoring actions of a process, a process tracking and Process Identification (PID) detection module for tracking actions of a process, abnormal actions of which have been detected, and detecting Process Identification (PID) of the process, a scenario blocking module for combining lists of actions taken by a relevant process for a given time period and blocking the relevant process when the actions match those of a composite scenario, a checksum blocking module for blocking a relevant process when a checksum of an execution program thereof matches a previously obtained checksum, a hooking detection and restoration module for, when an unwanted program is operating by injecting code into another process so as to conceal itself, detecting the unwanted program and restoring an original program, and an exceptional process database (DB) for examining a relevant process for an exception to action-based monitoring and then processing the relevant process as the exception to action-based monitoring; and
the security server comprises an analysis module for analyzing statistical information received from the user terminals, a security measure module for collecting information about abnormal actions occurring in the user terminals and blocking of unwanted programs in the user terminals, thus taking security measures, and an overall DB for storing information about blocking conditions, occurrence of abnormal actions on each of the user terminals, and unwanted programs.

10. The system according to claim 9, wherein the security server further comprises:
an exceptional process DB transferred to each of the user terminals and used to determine an exception to action-based monitoring; and
a blocking scenario DB transferred to the user terminal and used to perform process action-based matching and blocking

11. A program for detecting and blocking unwanted programs in real time based on process behavior analysis according to claim 1.

12. A recording medium for storing the program according to claim 11 in computer-readable form.
